(19) United States
(12) Patent Application Publication
(10) Pub. No.: US 2006/0109554 A1
(43) Pub. Date: May 25, 2006

(54) Diffractive optical lens, a mold for making the lens, and a method for making the mold

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/261,205

(22) Filed: Oct. 28, 2005

(30) Foreign Application Priority Data
Nov. 19, 2004 (TW) 93135559

(51) Int. Cl. G02B 5/18; G02B 27/44

(52) U.S. Cl. 359/566

(57) ABSTRACT

A diffractive optical lens (1) includes a lower surface (10) and an upper surface (12). The lower surface (10) has an aspheric curvature. The upper surface (12) has a quasi-parabolic curvature. A plurality of diffractive stripes (220) is formed on the upper surface (12). A mold (2) for making the diffractive optical lens (1) includes a lower core insert (20) and an upper core insert (22). The low core insert (20) has an aspheric surface (200). The upper core insert (22) has a surface configured for forming the upper surface (200) of the diffractive optical lens (1). A method for making the mold (2) is also provided.

### FIELD OF THE INVENTION

The present invention generally relates to optical lenses and, more particularly, to a diffractive optical lens.

### BACKGROUND

Currently, optical lenses are included in a wide variety of electronic devices, such as DVD players, digital cameras, digital projectors, and scanners. Most such electronic devices are becoming progressively more miniaturized over time. Nevertheless, in spite of the small size of a contemporary electronic device, consumers still demand excellent imaging. The image quality of a portable electronic device is mainly dependent upon the optical lenses.

Most contemporary optical lenses are aspheric lenses or spheric lenses. The aspheric lenses and spheric lenses each have a disadvantage of having some amount of aberration associated therewith when imaging. Diffractive optical lenses can decrease the disadvantage of image aberration, in comparison to the aspheric lenses and spheric lenses. However, the current diffractive optical lenses have diffractive stripes/strips in a same plane, which, in use, cannot efficiently decrease the disadvantage of image aberration.

A contemporary method for making diffractive optical lenses includes the steps of: providing a mold having faces corresponding to the diffractive optical lenses; guiding a lens material into the mold; solidifying the lens material; and obtaining a diffractive optical lens. The method needs an accurate mold, which has complex diffractive stripes. However, these diffractive stripes are so difficult to be machined that a mold surface cannot be readily made that possesses the desired pattern of diffractive stripes. Therefore, the diffractive optical lenses made in the above-mentioned mold can't meet the optical requirement.

What is needed is a diffractive optical lens which has little or no image aberration associated therewith and a method of producing such a lens.

### SUMMARY

A diffractive optical lens includes a lower surface and an upper surface. The lower surface has an aspheric curvature. The upper surface has a quasi-parabolic curvature. A plurality of diffractive stripes are formed on the upper surface.

A mold for making the diffractive optical lens includes a lower core insert and an upper core insert. The lower core insert has an aspheric surface. The upper core insert has a mold surface that is designed/configured for producing a particular chosen pattern/configuration of the upper surface of the diffractive optical lens.

A method for making the mold includes a series of steps. A first substrate and a second substrate are provided. The first substrate is ground and polished, so as to thereby obtain a lower core insert having an aspheric surface. The second substrate is, likewise, ground and polished, making the second substrate have a quasi-parabolic curvature. A precision machine having a linear motor is provided, and a diffractive optical formula is programmed into the precision machine. The quasi-parabolic curvature is then machined using the programmed precision machine. Accordingly, a plurality of diffractive-stripe molding surfaces are formed on the quasi-parabolic curvature, and an upper core insert is thereby obtained.

Other objects, advantages and novel features will become more apparent from the following detailed description when taken in conjunction with the accompanying drawings.

### BRIEF DESCRIPTION OF THE DRAWINGS

Many aspects of the lens, the mold, and the method for making the mold can be better understood with reference to the following drawings. The components in the drawings are not necessarily to scale, the emphasis instead being placed upon clearly illustrating the principles of the present lens, mold, and method for making the mold. Moreover, in the drawings, like reference numerals designate corresponding parts throughout the several views.

FIG. 1 is a cross-sectional view of a diffractive optical lens, in accordance with a preferred embodiment;

FIG. 2 is a schematic view of a mold, in accordance with a preferred embodiment, the mold being used to make the diffractive optical lens of FIG. 1;

FIG. 3 is a schematic view of a upper core insert, prior to machining thereof, in accordance with a preferred embodiment; and

FIG. 4 is a schematic view of a precision machine for making the mold in FIG. 2.

### DETAILED DESCRIPTION OF PERFERRED EMBODIMENT

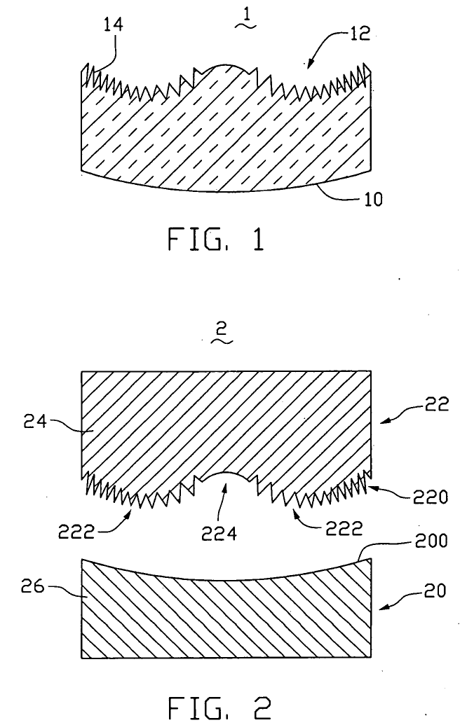

Referring to FIG. 1, in a preferred embodiment, a diffractive optical lens 1 includes a lower surface 10 and an upper surface 12. The lower surface 10 has an aspheric curvature, and the upper surface 12 has a quasi-parabolic curvature. A plurality of diffractive stripes or strips 14 are formed on the upper surface 12. The diffractive stripes 14 on the upper surface 12 are in accordance with a diffractive formula, such as Fresnel diffraction formula. While the diffractive stripes 14 are illustrated so as together to have a serrated form, it is to be understood that such stripes 14 could potentially be formed to take on any shape that produces a desired diffraction pattern and thus be within the scope of the present diffractive optical lens. The diffractive optical lens 1 is advantageously made of a transparent optical material, such as plastic or glass, the material being chosen on the basis of such characteristics as its refractive index, degree of transparency, hardness (i.e., scratch resistance), and mechanical toughness/durability, as well as the material cost and the ease of forming/machining such a material.

Referring to FIG. 2, in a preferred embodiment of an apparatus for forming the present diffractive optical lens 1, a mold 2 includes a lower core insert 20 and an upper core insert 22. The lower core insert 20 has an aspheric surface 200. The upper core insert 22 has a diffractive optical patterning surface 220, designed to inversely match the lens upper surface 12 that it is configured to produce (e.g., corresponding to locations on lens surface 12 where there are serration peaks (not labeled), V-shaped valleys (not labeled) are located in surface 220). The diffractive optical patterning surface 220, as illustrated, defines two diffraction-stripe molding zones 222, one each on opposite sides of a central arcuate zone 224. The diffraction-stripe zones 222 shown are serrated, an inverse match of the corresponding the diffractive stripes 14 of lens 1. As such, each diffraction-stripe molding zone 222 is formed based on a diffractive formula, such as a Fresnel diffraction formula.

The lower core insert 20 is formed of a first substrate 26, and the upper core insert 22 is formed of a second substrate 24. The first substrate 24 and the second substrate 26 are advantageously made of a same substrate material, such as tungsten carbide (WC). It is to be understood that any material that is sufficiently formable into a desired mold shape, that is capable of producing optical lenses with a desired surface finish, and that is sufficiently mechanically and chemically durable could be chosen as the material for either or both of substrates 24, 26. For example, various ceramic carbides and/or nitrides, or composites based thereupon, could potentially prove to be suitable substrate materials.

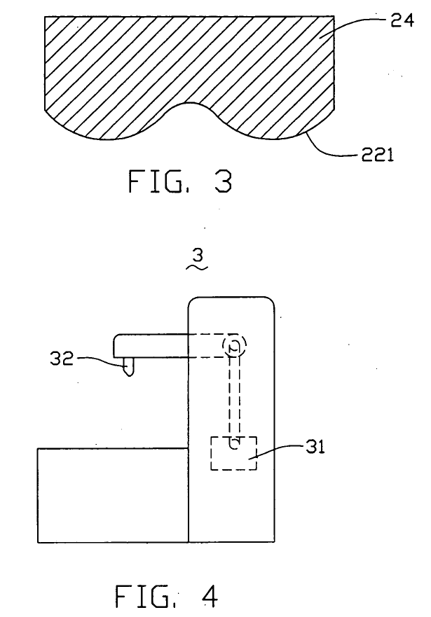

Referring to FIGS. 1, 2, 3 and 4, in a preferred embodiment, a method for making the mold 2 includes the steps of:

(1) providing a first substrate 26 and a second substrate 24, the first substrate 26 and the second substrate 24 being made of a same substrate material (e.g., tungsten carbide (WC));

(2) grinding and polishing the first substrate 26, thereby obtaining a lower core insert 20 having an aspheric surface 200;

(3) grinding and polishing the second substrate 24 so as to make the second substrate 24 have a quasi-parabolic curvature 221;

(4) providing a precision machine 3 having a linear motor 31;

(5) inputting/programming a diffractive optical formula into the precision machine 3, the diffractive optical formula being a Fresnel diffraction formula; and

(6) machining the quasi-parabolic curvature 221 by using the precision machine 3, a diffractive optical patterning surface 220 being formed within the quasi-parabolic curvature 221, an upper core insert 22 thereby being obtained.

Because the substrate material has a high rigidity and hardness, the precision machine 3 usefully includes a natural-diamond cutter 32, which usually exhibits a long working lifetime. Since a ball-screw motor has the associated disadvantage of producing high-frequency noise, the precision machine 3 advantageously uses the linear motor 31, which runs more quietly.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A diffractive optical lens, comprising:
a lower surface having an aspheric curvature; and
an upper surface having a quasi-parabolic curvature, the upper surface further including a plurality of diffractive stripes.

2. The diffractive optical lens as claimed in claim 1, wherein the diffractive optical lens is made of a material selected from a group consisting of plastic and glass.

3. The diffractive optical lens as claimed in claim 1, wherein the diffractive stripes are shaped in accordance with a Fresnel diffraction formula.

4. The diffractive optical lens as claimed in claim 1, wherein the diffractive stripes together define a serrated form.

5. A mold for making a diffractive optical lens, comprising:
a lower core insert having an aspheric surface;
an upper core insert having a diffractive optical patterning surface, the diffractive optical patterning surface being configured for molding an upper surface of the diffractive optical lens, the upper surface having a quasi-parabolic curvature, the upper surface further including a plurality of diffractive stripes.

6. The mold as claimed in claim 5, wherein the lower core insert and upper core insert are comprised of tungsten carbide.

7. The mold as claimed in claim 5, wherein the diffractive optical patterning surface includes at least one diffraction-stripe molding zone.

8. The mold as claimed in claim 7, wherein each diffraction-stripe molding zone has been shaped in accordance with a Fresnel diffraction formula.

9. The mold as claimed in claim 7, wherein each diffraction-stripe molding zone has a serrated form.

10. A method of making a mold, the mold being configured for forming a diffractive optical lens, the method comprising the steps of:
providing a first substrate and a second substrate;
grinding and polishing the first substrate, thereby obtaining a lower core insert having an aspheric surface;
grinding and polishing the second substrate, thereby making the second substrate have a quasi-parabolic curvature;
providing a precision machine and programming a diffractive optical formula in the precision machine;
machining the quasi-parabolic curvature by using the programmed precision machine so as to form a plurality of diffractive stripes within the quasi-parabolic curvature, the second substrate with the machined quasi-parabolic curvature thereby having been formed into an upper core insert.

11. The method as claimed in claim 10, wherein the precision machine has a natural-diamond cutter.

12. The method as claimed in claim 10, wherein the precision machine includes a linear motor.

13. The method as claimed in claim 10, wherein the diffractive optical formula used is a Fresnel diffraction formula.
